(19) United States
(12) Patent Application Publication
(10) Pub. No.: US 2011/0220151 A1
(43) Pub. Date: Sep. 15, 2011

(54) Method and Apparatus for Washing Downhole Tubulars and Equipment

(76) Inventor: Jerry L. Swinford, Spring, TX (US)

(21) Appl. No.: 13/046,662

(22) Filed: Mar. 11, 2011

Related U.S. Application Data
(60) Provisional application No. 61/312,838, filed on Mar. 11, 2010.

(51) Int. Cl. B08B 9/032

(52) U.S. Cl. 134/22.12; 134/166 R

(57) ABSTRACT

A washing assembly having at least one nozzle in fluid communication with at least one fluid source. The at least one nozzle is angled slightly inwards and downwards towards the internal bore of the washing assembly. The washing assembly is placed in functional relation to a wellbore. The tubular within the wellbore is passed along the washing assembly and through pressurized fluid supplied thereby, whereby NORM and other materials are washed from the tubular down into the wellbore. Further, the methods disclosed include use of the disclosed washing assembly or other washing assemblies used for the purpose of removing material from downhole tubular and like materials. The washing assembly is positioned within a wellbore such that it is sufficiently retained therein. A fluid source is coupled to the washing assembly to provide pressurized fluid thereto. The fluid provided may be augmented with cleaners or other chemicals to aid in the removal of the NORM and/or other material contained on the tubulars, and/or to aid in neutralizing the NORM. The pressurized fluid is introduced into the wellbore and the tubular is extracted through the exerted fluid. The NORM and other material is washed down into the borehole. One or more washing assemblies may be positioned along the length of the wellbore as needed.

### CROSS-REFERENCE TO RELATED APPLICATIONS

This application claims the benefit of U.S. Provisional Ser. No. 61/312,838 filed on Mar. 11, 2010 in the United States Patent and Trademark Office, which application is incorporated herein by reference as if reproduced in full below.

### STATEMENT REGARDING FEDERALLY SPONSORED RESEARCH OR DEVELOPMENT

Not Applicable.

### FIELD OF THE DISCLOSURE

The disclosure relates to a method and an apparatus for the removal of material from downhole tubulars, namely, the removal of naturally occurring radioactive material and the deposit of same within the borehole.

### BACKGROUND

Naturally occurring radioactive material (NORM) is found nearly everywhere: in the air, soil, some foods that we eat, and even in our bodies. Trace amounts of NORM are brought to the surface during the production of hydrocarbons from subterranean formations. The radioactive material is typically suspended in formation waters produced from a reservoir and is carried to the surface with the waters. The radioactive material collects on surfaces and tends to concentrate and accumulate on oil field tubulars and production equipment over time, thereby contaminating them with potentially unsafe levels of radiation. The radioactive materials must be removed from the oil field tubulars and production equipment for approved disposal.

Tubulars and other downhole equipment are brought to the surface where they are treated to remove the naturally occurring radioactive material. An effect of bringing these items to the surface prior to removal of the NORM is that employees handling the equipment and working at the site may be exposed to the radioactive materials. Further, once the material is removed from the tubulars it must still be disposed of according to state and/or federal regulations adding additional steps and cost to the production process.

Commonly the NORM and other waste material is disposed of in pits or subterranean locations. A common method of disposal is through the formation of an injection borehole created and formed for the sole purpose of direct pumping of the waste into same wherein the material is prepared on the surface prior to injection into the injection borehole. Chemicals and other treatments have also been developed to address the disposal and treatment of NORM. Further, the material may need to be prepared prior to its disposal, such as by adding weighing material, removing excessive amounts of oil and grease, and/or diluting the material to reduce the level of radioactivity. The preprocessing of the material can add significant costs to the disposal process.

### BRIEF SUMMARY OF THE DISCLOSURE

The disclosure relates to a method and apparatus for cleaning tubulars and other downhole equipment as they are being removed from the borehole. The apparatus consist of a washing assembly having at least one nozzle bore in fluid communication with at least one external fluid source. At least one channel may be formed to functionally couple the pressurized fluid source to the nozzle bore. The at least one nozzle bore is angled slightly inwards and downwards toward the internal bore of the washing assembly.

The washing assembly is placed in functional relation to a wellbore. The tubular within the wellbore is passed along the washing assembly. Pressurized fluid is passed through the washing assembly and directed towards the tubular. The tubular is pulled through the washing assembly whereby NORM and other materials are washed from the tubular.

The methods disclosed include use of the disclosed washing assembly or other downhole washing assemblies used for the purpose of removing material from downhole tubular and like materials and depositing said material within the wellbore. The washing assembly is positioned within a wellbore such that it is sufficiently retained therein. The washing assembly may be positioned proximate the surface opening of the wellbore. A fluid source is coupled to the washing assembly to provide pressurized fluid thereto. The fluid provided may be augmented with cleaners or other chemicals to aid in the removal of the NORM and/or other material contained on the tubulars, and/or to aid in neutralizing the NORM. The pressurized fluid is introduced into the wellbore and the tubular is extracted through the exerted fluid. The NORM and/or other materials are washed down into the borehole.

One or more washing assemblies may be positioned along the length of the wellbore as needed.

Other features will be apparent from the following detailed description, the accompanying drawings, and the appended claims.

### BRIEF DESCRIPTION OF THE DRAWINGS

FIG. 1 is a cross-section of an exemplary embodiment of the washing apparatus situated around a tubular.

FIG. 2 is a cross-section of the exemplary embodiment of the washing apparatus of FIG. 1.

FIG. 3A is a perspective view of the non-mating side of the lower module of the exemplary embodiment of FIG. 1.

FIG. 3B is a perspective view of the mating side of the lower module of the exemplary embodiment of FIG. 1.

FIG. 4 is a cross-section of the lower member of FIG. 3B through line 4-4.

FIG. 5 is a perspective view of the mating side of the upper module of the exemplary embodiment of FIG. 1.

FIG. 6 is a cross-section of the upper member of FIG. 5 through line 6-6.

FIG. 7 is cross-section of the washer assembly of FIG. 1.

FIG. 8 is a cross section of the upper member showing a fluid fitting dock.

FIG. 9 is a cross-section of an alternative embodiment of the disclosure.

FIG. 10 is a cross-section of alternative embodiment of the disclosure.

FIG. 11 is a perspective view of an alternative embodiment of the washing apparatus.

### DESCRIPTION OF EXAMPLE EMBODIMENTS

The exemplary embodiment is best understood by referring to the drawings, like numerals being used for like and corresponding parts of the various drawings. The directions “lower” and “upper” as used in this specification are used for descriptive purposes only and it will be understood by one having skill in the art that different orientations are possible.

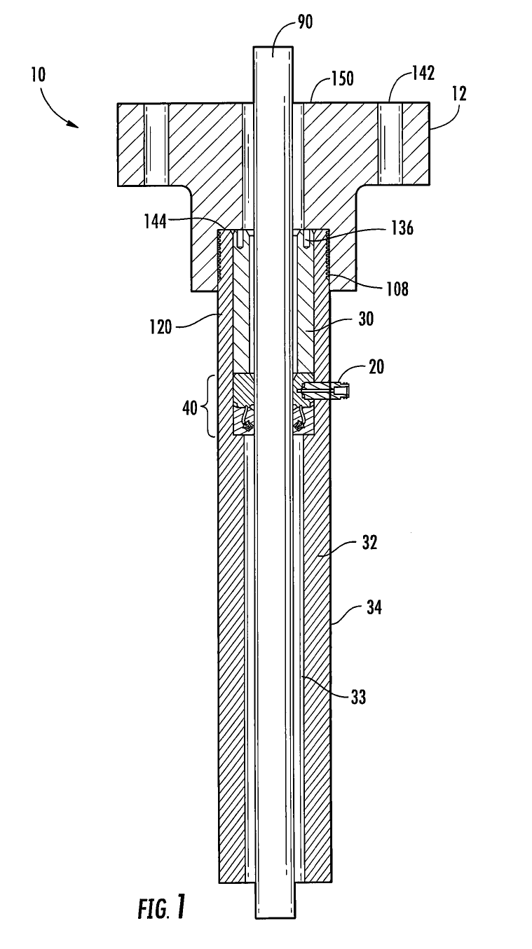

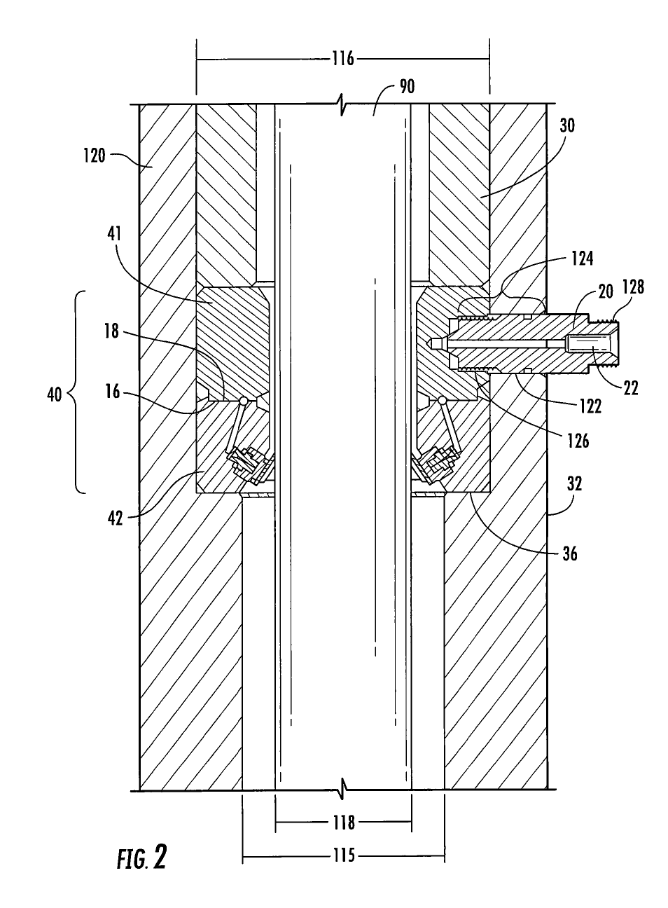

Referring to FIGS. 1 and 2, an exemplary embodiment of the washing apparatus 10 generally comprises a washer assembly 40 having at least one nozzle bore 54 and being capable of functional coupling to a pressurized fluid source and retained placement within a borehole.

The exemplary embodiment of the washer assembly 40 generally includes an upper member 41 and a lower member 42. The upper member 41 and lower member 42 are operationally coupled along their respective mating ends 16 and 18.

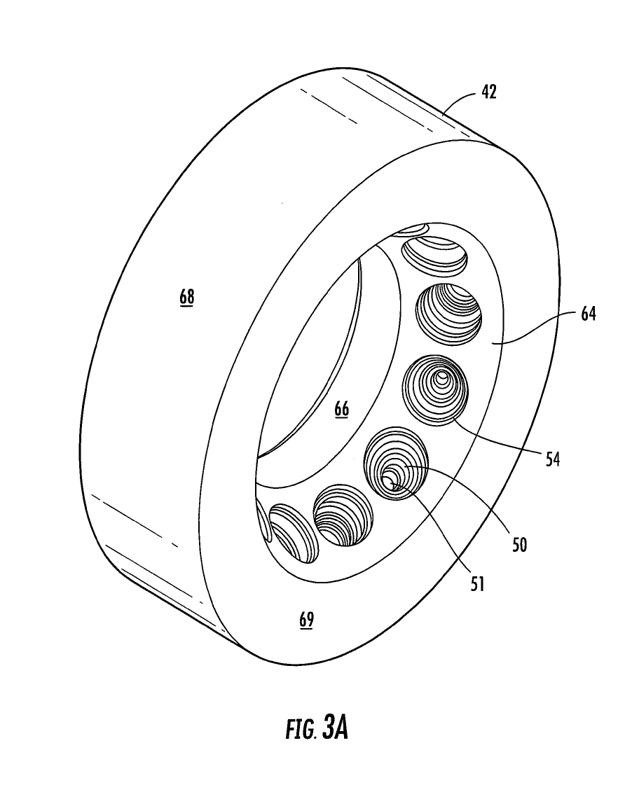

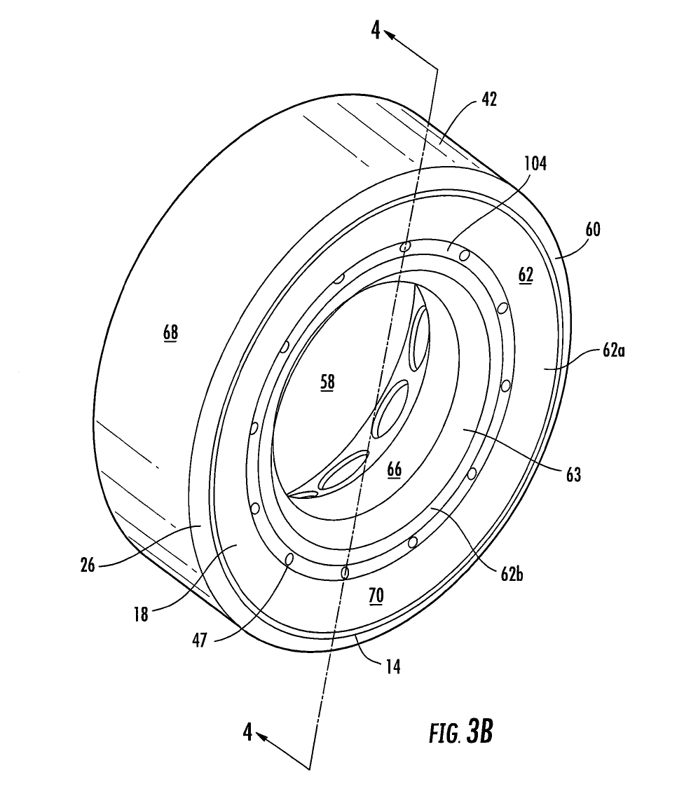

Referring to FIGS. 1, 3A and 3B, the lower member 42 is generally annular and is sized such that it can at least partially encircle at least a portion of a length of tubular 90. Tubular 90 may include coil tubing, drill pipe, drill collars, casing, production tubing, pipeline, or any other type of tubular utilized in downhole operations.

The lower member 42 is the lower half of the washer assembly 40. The lower member 42 has an upper surface 70 and corresponding lower surface 69, and an innermost surface 66 and corresponding outer surface 68. An annular, sloped nozzle bore surface 64 lies intermediate the inner surface 66 and the outer surface 68. At least one nozzle bore 54 is formed into the sloped nozzle bore surface 64. The at least one nozzle bore 54 is a generally annular opening. The nozzle bore 54 defines a fluid passageway from a position interior of the lower member 42 to a position exterior of the lower member 42.

The diameter of the nozzle bore 54 may be increased or decreased depending on the amount of fluid flow and/or pressure desired to flow therethrough. A purpose of the at least one nozzle bore 54 is to allow for fluid communication between the interior of the washing assembly 40 and the exterior of the washing assembly and/or the internal bore 58 of the washing assembly 40, wherein the internal bore 58 extends axially through the washing assembly 40. That is, a purpose of the at least one nozzle bore 54 is to provide fluid communication between the source of pressurized fluid and the exterior of the downhole tubular 90 positioned proximate the washing assembly 40.

Alternatively, there may be more than one row or column of nozzle bores 54 and/or nozzles 50. Alternatively, the nozzle bores 54 and/or nozzles 50 may be contained in a staggered configuration or any other configuration that allows for the desired number of nozzle bores 54 and/or nozzles 50. A purpose of the nozzle bores 54 and/or nozzles 50 is to wash undesired material from the tubular 90 and allow that material to be washed downhole while the tubular 90 is brought to the surface.

To facilitate coupling with the upper member 41, the upper surface 70 of the lower member 42 has a generally annular protrusion 60 extending upward, longitudinally along the perimeter of the upper surface 70 defining a recessed upper surface 70. In the exemplary embodiment depicted, at least a portion of the protrusion 60 is sloped or angled inward, toward the internal bore 58, with respect to the outer surface 68. This external slope 26 may provide a location for a welded connection with the upper member 41. This slope 26 may not be present in all embodiments of the disclosure.

The sloped interior surface 63 of the upper member 41 is generally annular and extends around the internal bore 58 of the washing assembly 40. The sloped interior surface 63 is disposed intermediate the innermost surface 66 and the recessed upper surface 70. At least a portion of the sloped interior surface 63 is angled or sloped outward towards the outer surface 68 with respect to the innermost surface 66 and the internal bore 58. This outward slope 63 may provide a location for a welded connection with the upper member 41. This slope 63 may not be present in all embodiments of the disclosure.

The sunken mating surface 62 extends along at least a portion of the recessed upper surface 70. The sunken mating surface 62 is disposed in a lower position with respect to the apex 14 of the protrusion 60 that extends longitudinally upward and around at least a portion of the perimeter of the recessed upper surface 70. The sunken mating surface 62 is disposed intermediate the sloped interior surface 63 and the protrusion 60.

The sunken mating surface 62 contains a generally annular groove 104 extending along at least a portion of the recessed surface 70. The groove may traverse along the entire annular length of the sunken mating surface 62, thus dividing the sunken mating surface 62 into portions: the exterior portion 62a and the interior portion 62b. Alternatively, more than two portions 62a, 62b may be formed with the use of one or more grooves 104 and/or one or more discontinuous grooves 104.

In the exemplary embodiment depicted, the groove 104 is disposed intermediate the annular portions 62a and 62b. The annular portions 62a and 62b need not be equal in width. The sides of each respective annular portion 62a and 62b that is proximate the groove 104 defines the width of the groove 104. A purpose of the groove is to allow for fluid flow from the upper member 41 to be dispersed to the nozzle bores 54 of the lower member 42. This flow, from one or more fluid sources that are operationally coupled to the upper member 41, may be achieved through the use of one or more grooves 104 which allow the fluid to flow therein facilitating the fluid's entry into the lower member 42 for dispersement through one or more nozzle bores 54.

At least one lower fluid port 47 is disposed within the groove 104. The at least one fluid port 47 provides fluid communication between a source of fluid external to the interior of the lower member 42 and the interior 58 of the lower member 42. A plurality of fluid ports 47 may be provided along the length of the groove 104. The number of fluid ports 47 may equal the number of nozzle bores 54. A purpose of the fluid port 47 is to allow fluid communication between the exterior and interior of the lower member 42. A further purpose of the fluid port 47 is to allow fluid communication from the upper member 41 to the lower member 42.

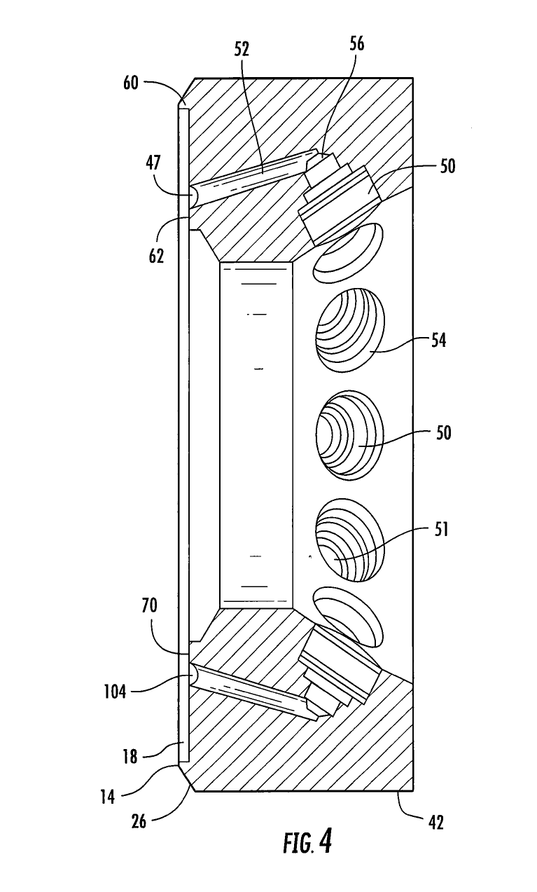

Referring to FIGS. 3A, 3B and 4, at least one nozzle 50 is operationally coupled to a corresponding nozzle bore 54. The nozzle opening 51 is disposed proximate the nozzle bore 54. At least one fluid channel 52 is operationally coupled to at least one nozzle 50 and/or at least one nozzle bore 54 at a connection junction 56. The at least one fluid channel 52 is formed within the interior of the lower member 42. The fluid channel 52 extends longitudinally upward, from the connection junction 56, towards the upper surface 70 and ends proximate a lower fluid port 47 that is displaced within the groove 104. The fluid channel 52 is disposed intermediate the nozzle opening 54 and fluid port 47 allowing fluid communication there between.

The at least one nozzle 50 and corresponding fluid channel 52 are contained within the body of the lower member 42. The nozzle 50 and/or the fluid channel 52 may be integrally formed within the lower body member 42. A purpose of the nozzle 50 and fluid channel 52 is to allow a fluid to enter the lower member 42 proximate the recessed upper surface 70, and to allow for the expulsion of that fluid proximate the lower surface 69. The slope of the nozzle bore surface 64 at least slightly angles the ejected fluid towards the centrally extending longitudinal axis of the internal bore 58 of the washing assembly 40. This angle may vary depending on the desired positioning of the nozzles 50 and/or nozzle bores 54.

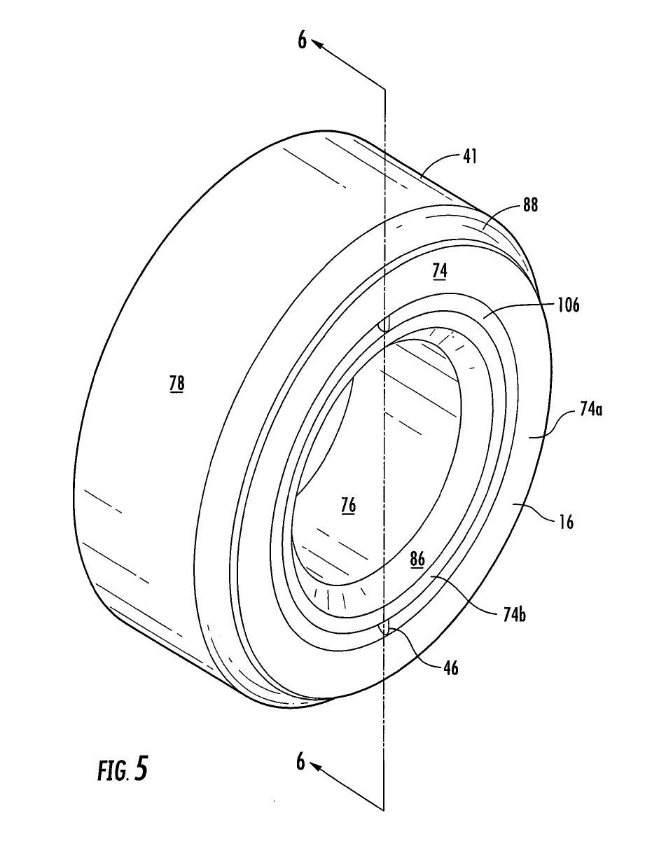

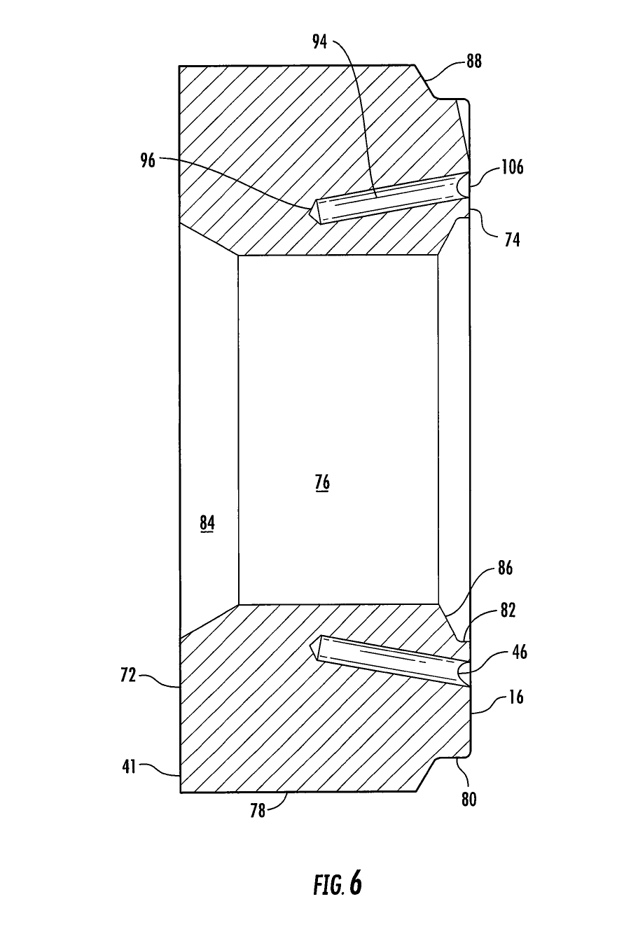

Referring to FIGS. 5 and 6, upper member 41 is generally annular and is sized such that it can at least partially encircle at least a portion of a length of tubular 90. The upper member 41 is the upper half of the washer assembly 40. The upper member 41 has an upper surface 72 and corresponding lower protruding mating surface 74, an inner medial surface 76, extending around the internal bore 58, and an outer surface 78, extending laterally around the outer periphery of the upper member 41.

The upper surface 72 may have an annularly extending sloped section 84. The sloped portion 84 is disposed intermediate the upper surface 70 and the inner medial surface 76. The sloped section 84 may be angled in relation to the inner medial surface 76 wherein the angle tapers outward from the inner medial surface 76 proximate the upper surface 72.

At least a portion of the outer surface 78 slopes inward 88 along the outer periphery of the upper member 41 proximate the protruding mating surface 74. This sloped external surface 88 may provide a location for a welded connection with the lower member 42. This slope 88 may not be present in all embodiments of the disclosure.

The sloped external surface 88 abuts a generally annular, laterally downwardly extending external sidewall 80. The external sidewall 80 defines at least a portion of the outer perimeter of the protruding mating surface 74. The external sidewall 80 is intermediate the protruding mating surface 74 and the sloped external surface 88.

A sloped internal surface 86 extends around the inner periphery of the upper member 41 proximate the protruding mating surface 74. At least a portion of the sloped internal surface 86 is angled outward with respect to the inner medial surface 76. The slope begins proximate the inner medial surface 76 and tapers outward toward the protruding mating surface 74. This sloped internal surface 86 may provide a location for a welded connection with the lower member 42. This slope 86 may not be present in all embodiments of the disclosure.

The sloped internal surface 86 abuts a generally annular, laterally upwardly extending internal sidewall 82. The internal sidewall 82 defines at least a portion of the inner perimeter of the protruding mating surface 74. The internal sidewall 82 is intermediate the protruding mating surface 74 and the sloped internal surface 86.

The sloped internal surface 86 and sloped external surface 88 may be the same length or may be of varying lengths. Similarly, the internal sidewall 82 and the external sidewall 80 may be of varying lengths or may be the same length.

The protruding mating surface 74 is generally annular and generally extends between at least a portion of the external sidewall 80 and the internal sidewall 82. The protruding mating surface 74 contains a generally annular groove 106 extending thereon along at least a portion of the protruding mating surface 74. The groove 106 may traverse the entire annular length of the protruding mating surface 74, thus dividing the protruding mating surface 74 into portions: the exterior portion 74a and the interior portion 74b. The annular portions 74a and 74b need not be equal in width. Alternatively, more than two portions 74a, 74b may be formed through the use of one or more grooves 106 and/or one or more discontinuous grooves 106.

In the exemplary embodiment depicted, the groove 106 is disposed intermediate annular portions 74a and 74b of the protruding mating surface 74. The side of each respective annular portion 74a and 74b that is proximate the groove 106 defines the width of the groove 106. A purpose of the groove is to allow for fluid flow from the upper member 41 to be dispersed to the nozzle bores 54 of the lower member 42. This flow, from one or more fluid sources that are operationally coupled to the upper member 41, may be achieved through the use of one or more grooves 106 which allow the fluid to flow therein, thereby facilitating the fluid's entry into the lower member 42 for dispersement through the nozzle bores 54.

At least one upper fluid port 46 is disposed within the groove 106. The fluid port 46 facilitates fluid communication between a fluid source and the lower member 42. A plurality of fluid ports 46 may be provided along the length of the groove 106. The plurality of fluid ports 46 may be positioned in uniform succession or may be non-uniformly positioned. The number of fluid ports 46 may equal the number of nozzles 50 and/or nozzle bores 54 or may be less than or more than the number of nozzles 50 and/or nozzle bores 54. A purpose of the fluid ports 46 is to allow fluid communication between the source of fluid and the nozzle bores 54.

At least one fluid port 46 is functionally coupled to at least one fluid channel 94, wherein the fluid channel 94 extends at least partially within the upper member 41. The at least one fluid channel 94 terminates at a connection junction 96 distal the groove 106 within the interior of the upper member 41. The connection junction 96 is capable of operational connection to the source of fluid; however, not all connection junctions 96 located within the upper member 41 need to be so connected. This functional connection allows for fluid communication between the source of fluid and at least one fluid port 46.

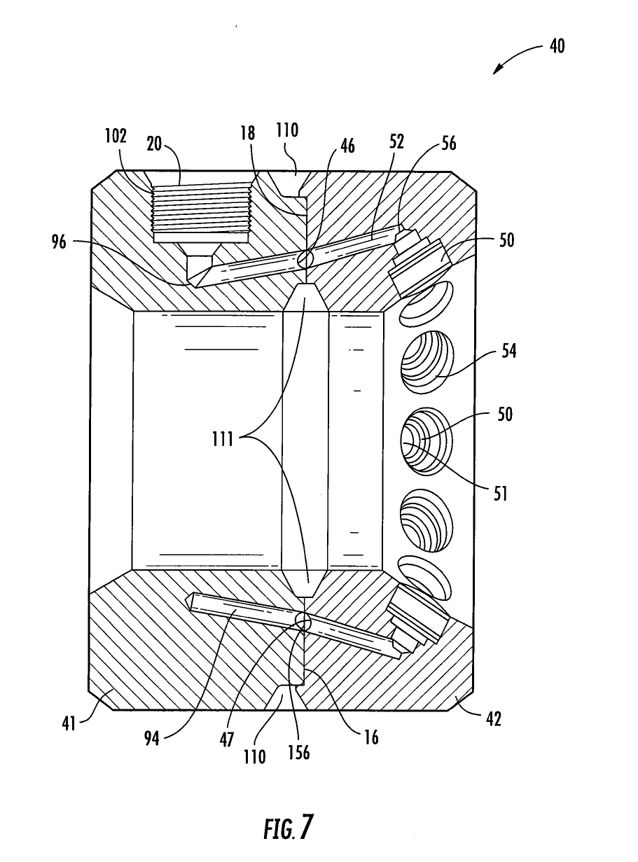

Referring to FIG. 7, upper member 41 and lower member 42 are functionally coupled at their respective mating ends 16, 18 to produce the washer assembly 40. The members 41, 42 may be welded, bolted, screwed, or combined in any other known manner. Alternatively, the members 41 and 42 may be integrally formed out of a single piece of material. Alternatively, the washer assembly 40 may be broken into more than two pieces and functionally combined to serve its purpose.

Alternatively, the washing assembly 40 may be made up of a one or more independent pieces, each operationally coupled to a fluid source. Wherein the independent pieces each contain at least one nozzle bore 54 and at least one fluid channel 52 and/or 94 to allow for the flow of the fluid from the fluid source through at least one nozzle bore 54 and onto at least a portion of the exterior of a tubular 90, or other downhole component.

The configuration of the sunken mating surface 62 and the protrusion 60 of the lower member 42, and the protruding mating surface 74 of the upper member 41 allows for operational coupling of the upper 41 and lower 42 members. However, any configuration that allows operational coupling of the lower member 42 to the upper member 41 may be utilized while retaining the teachings and spirit of this disclosure.

In the embodiment depicted, the upper member 41 and lower member 42 are functionally coupled through a welding process; however, any known or later discovered method of coupling may be utilized. The external sloped surface 26 of the lower member 42 and the external sloped surface 88 of the upper member 41 define a welded section 110. The internal slopped surface 63 of the lower member 42 and the internal slopped surface 86 of the upper member 41 define a second welded section 111. A purpose of the welded sections 110, 111 is to allow for the coupling of the upper 41 and lower 42 members; therefore, these sections 110, 111 may not be necessary depending on the manner with which the upper 41 and lower 42 members are operationally coupled.

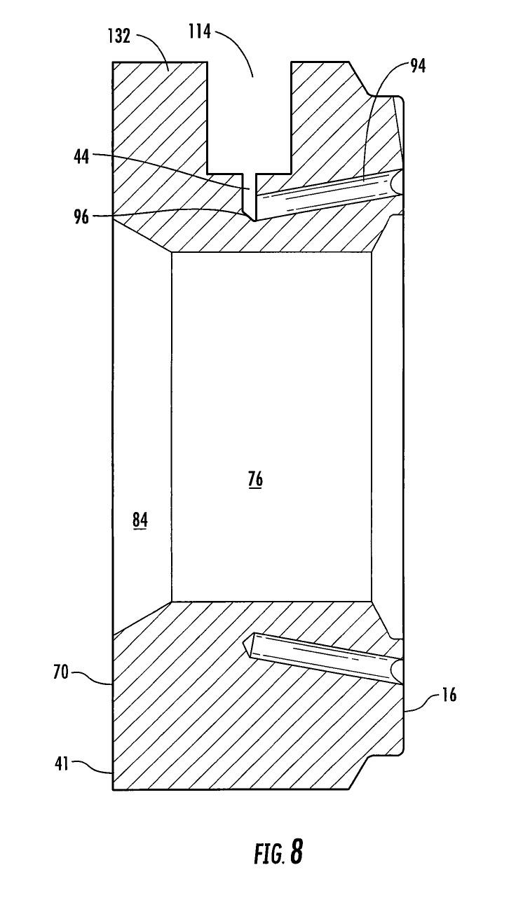

Referring to FIGS. 7 and 8, in the exemplary embodiment shown, there are two diametrically opposed fluid channels 94; shown as being formed within the upper member 41. At least one fluid fitting dock 114 is formed within a wall 132 of the upper member 41. The fluid fitting dock 114 may be drilled or formed in any known or later discovered manner. The dock 114 provides the orifice for at least the partial insertion of a fluid fitting 20 and is shaped to allow functional attachment of at least a portion of the fluid fitting 20 therein. The fluid fitting 20 allows for fluid communication between the source of the fluid and the washing assembly 40. The fluid entry channel 44 couples with the connection junction 96 to allow for fluid communication between the two. The fluid fitting 20 operationally couples to the fluid fitting dock 114 via corresponding threading 102; however, any known or hereinafter discovered method of operationally coupling the fluid fitting 20 to the fluid channel 94 and/or nozzle bore 54 and/or nozzle 50 may be utilized.

A purpose for this configuration, i.e., having at least one fluid channel 94 that is not coupled to a fluid fitting dock 114, is to allow for fluid flow through a single fluid channel 94 that is operationally coupled with the fluid fitting 20. The fluid will enter the grooves 104, 106 and be distributed to the fluid channels 52 in the lower member 42. If during operation an issue arises with the fluid flow, whether by clogging or deterioration of the fluid channel 94, or some other issue wherein the fluid cannot proceed to the nozzle bores 54, then another fluid channel 94 may be utilized. If desired, the installed fluid fitting 20 may be removed from the dock 114. The dock 114 may be sealed to prevent loss of fluid pressure and/or fluid flow therethrough. Another dock 114 may be formed at a different location along wall 132 of the upper member 41 proximate another fluid channel 94. The same fluid fitting 20, or a different fluid fitting 20, may be attached thereto and functionally coupled to the other fluid channel 94, thereby allowing for continuation of the washing process. This procedure allows for a quick change out providing minimal interruption of the cleaning services.

A plurality of channels 94 may be formed within the upper member 41 to allow for further contingencies in the case of malfunction or for concurrent use of more than one channel 94 if so desired. Alternatively, more than one fluid fitting 20 and/or fluid channel 94 may be utilized as needed to produce the desired fluid flow and/or pressure.

Alternatively, the number of lower member ports 47 and upper member ports 46 may be equal. Alternatively, there may be more lower member ports 47 than upper member ports 46. Alternatively, there may be more upper member ports 46 than lower member ports 47.

Alternately, the number of nozzle bores 54 and/or nozzles 50 may be sufficient to provide 360 degree fluid coverage along the exterior of the downhole tubular 90. The number of nozzle bores 54 and/or nozzles 50 may vary depending on the amount of wash pressure and fluid coverage desired. Further, the number of nozzle bores 54 and/or nozzles 50 may vary depending on the size of the outer diameter of the downhole tubular 90.

In an alternative embodiment, nozzle bores 54 and/or nozzles 50 may be disposed along both the upper 41 and lower 42 members' inner surfaces. Fluid sources may be introduced to both the upper 41 and lower 42 members in order to produce the desired level fluid pressure along the tubular 90. Channels 156 may be formed within each of the upper 41 and lower 42 members in order to distribute the fluid flowing from the fluid source to the nozzle bores 54 for expulsion therefrom.

Referring to FIGS. 1-2 and 9-10, a spool 32 is a generally elongated member that contains an inner spool wall 33 and an outer spool wall 34. At least a portion of the inner diameter 115 of the spool 32 is greater than the outer diameter 118 of the downhole tubular 90, or other downhole item to be cleaned. This allows for extraction of the downhole tubular 90 through the interior of the spool 32. A purpose of the spool is to contain said washing assembly 40 and said tubular 90 in functional relations to said borehole/wellbore in order to perform the washing of the tubular.

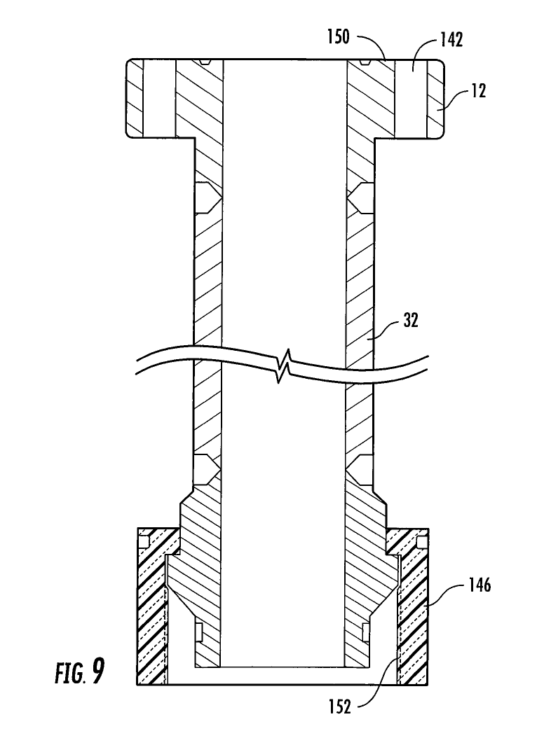

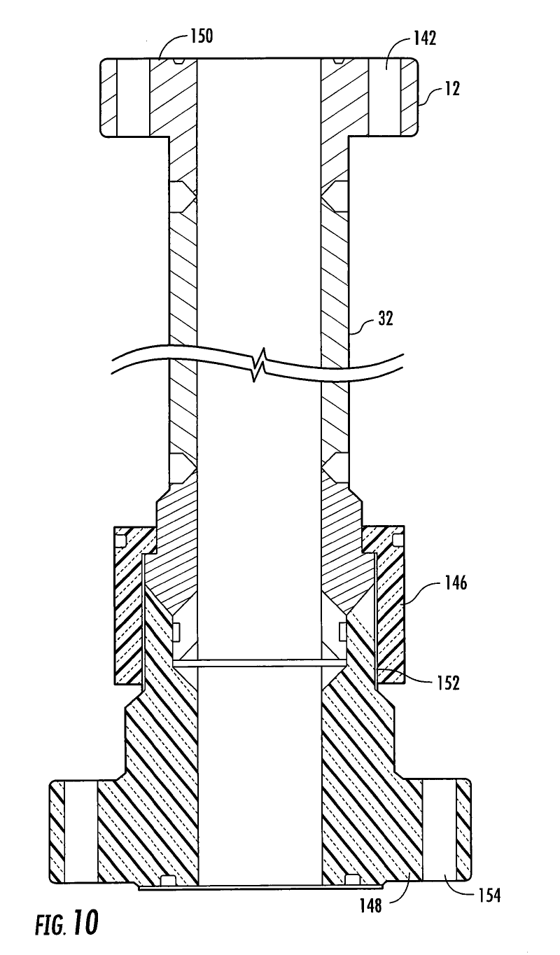

The inner diameter 115 of the spool 32 of the exemplary embodiment of FIGS. 1 and 2 is not of a uniform length. The inner diameter increases 116 at the upper section 120 of the spool 32, proximate the upper opening 144 of the spool 32 (this feature is not present in FIGS. 9-10). The base of the increased inner diameter 116 forms a seat 36 that may be used to support the washing assembly 40. Alternatively, the washing assembly 40 may be supported along the spool 32 in any known or later discovered manner such by being bolted to the inner wall 33 of the spook 32 or by connection to the borehole wall itself, and the like. A purpose of the increase in diameter 116 is to support the placement of the washing assembly 40 along the spool 32.

At least one cavity 122 is formed in the side of the spool 32. The cavity 122 extends from the outer wall 34 through the inner wall 33. The cavity 122 corresponds to a fluid fitting dock 114 within the washing assembly 40. The cavity 122 and fluid fitting dock 114 define an installation slot 124 for the fluid fitting 20.

The fluid fitting 20 contains a bore 22 longitudinally extending therethrough. The fluid fitting bore 22 acts as a conduit for pressurized fluid entering through the external connection end 128 and exiting through the washer assembly connection end 126 of the fluid fitting 20. The external connection end 128 functionally connects to a source of pressurized fluid (not shown). The washer assembly connection end 126 at least partially connects to the washer assembly 40 to allow flow therethrough of the pressurized fluid that will act on the debris, including but not limited to naturally occurring radioactive material, and flush at least some of the debris off of the downhole tubular 90 and back into the well bore.

A purpose of the at least one fluid fitting 20 is to provide fluid to the washer assembly 40. In an exemplary embodiment, the fluid is pressurized at or about 23,000 psi. Alternate embodiments may provide for alternate pressures a needed and/or desired to produce the desired effect.

In use, the washing assembly 40 is contained within the spool 32, and rests upon the seat 36 within the larger inner diameter section 116 of the spool 32. A retainer 30 may be used to aid in the retention of the washing assembly 40 within the spool cavity. The pressure produced within the washing assembly 40, and adjacent areas, may act on the washing assembly 40 thereby changing the position of the washing assembly 40 relative to the spool 32. A purpose of the retainer is to prevent axial movement of the washing assembly 40 along the spool 32 and/or tubular 90. The retainer 30 is a generally annular member that is sized to extend within at least a portion of the spool 32 while allowing axial movement of the subject tubular member 90 through the spool 32. Generally, the retainer 30 is disposed intermediate the washing assembly 40 and the upper opening 144 of the spool 32.

The retainer 30 may contain bolt holes 136; these holes 136 will be proximate the upper opening 144 of the spool 32 when the retainer is in position within the spool 32. The bolt holes 136 allow for connection of the retainer 30 to the sleeve 12 in order to facilitate the removal of the retainer 30 and/or the spool 32 and/or the washing assembly 40. A purpose of the sleeve 12 is to facilitate the removal of the washing assembly and/or associated items 30, 32. Alternatively, the sleeve 12 may be constructed to contain an integrated retainer 30, or may be used in conjunction with other retaining devices. Alternatively, the washing assembly 40 may be positioned proximate the spool opening 144 whereby a retainer 30 is not necessary as the washing assembly 40 will be retained by the sleeve 12 and/or other component that is connected to the spool 32.

In the exemplary embodiment shown, the sleeve 12 is attached to the upper opening 144 of the spool 32 proximate the retainer 30. The sleeve 12 and spool 32 are coupled by corresponding threading 108; however, any known or hereinafter discovered method of operationally coupling the sleeve 12 to the spool 32 may be utilized. The coupling of the sleeve 12 to the spool 32 retains the retainer 30 and washing assembly 40 within the larger inner bore 116 of the spool 32. This prevents the washing assembly 40 from substantially traveling within the spool 32 whether on its own or as a result of the pressurized fluid escaping through the nozzle bores 54.

The sleeve 12 may be integrally formed with the spool 32 as in FIGS. 9 and 10. In this instance the washing assembly is prevented from substantial axial movement by the equipment or apparatus, such as a gooseneck (not shown) or the like, that is attached to the sleeve at its upper end 150.

The bores 142 extending through the sides of the sleeve 12 allow for connection to a coiled tubing rig, or other rig or apparatus through which the tubular 90 will be passed. In an alternative embodiment, the sleeve 12 does not have the bores 142 but instead has internal or external threading for attachment to a gooseneck or the like. The purpose of the bores 142 or threading is to functionally connect the washing apparatus 40 to the tubular 90 extractor mechanism such that the tubular 90 will be washed by the washing assembly 40 as it is being removed from the wellbore by the extractor mechanism. This purpose may be accomplished by any known or later discovered coupling procedure.

Alternatively, the washing assembly 40 may be integrally formed within the spool 32 thereby negating the need for a retainer 30. Alternatively, at least a portion of the washing assembly 40 may encompass the retainer 30. Alternatively, the retainer 30 may be attached, either removably or fixedly, to at least a portion of the washing assembly 40.

Referring to FIGS. 9 and 10, an adapter 148, may be attached to the spool 32 by a collar nut 146. The collar nut 146 may be threadedly connected to the adapter 148 by corresponding threads 152, though any alternative connection means will serve the same purpose. Alternatively, the adapter 148 may be integrally formed with the spool 32.

The adapter 148 allows for functional connection of the washing assembly 40 with the wellbore (not shown). This connection may be through the use of a rig lubricator or other apparatus as desired. The external connections formed by the adapter 148 and the sleeve 12 allow the washing assembly 40 to be contained in a functional relationship with the tubular 90 within the wellbore so that the tubular 90 may be cleaned as it is being removed from the wellbore in order to prevent hazardous and/or nonhazardous material from being brought out of the wellbore. The material being removed from the tubular 90 will be washed into the wellbore and will thus be prevented from being exposed to the surface.

The adapter 148 may have bores 154 to aid in the connection to the wellbore either directly or through other devices. Typically, this is for use with jointed pipe. Alternatively, the adapter 148 may have internal or external threading with which to functionally connect to the wellbore either directly or through other devices.

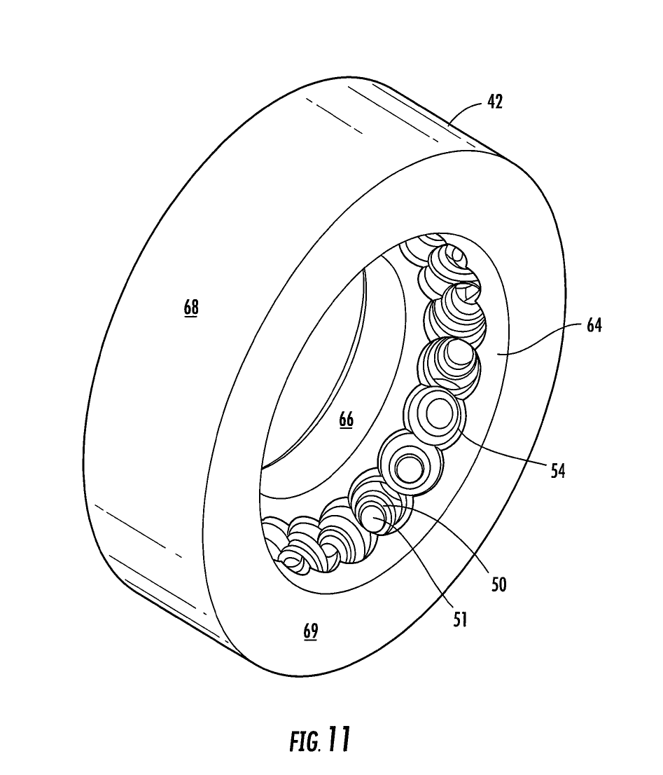

FIG. 11 depicts an alternative embodiment of the washing assembly 40. The washing assembly 40 is depicted with a continuous ring of nozzle bores 54 and nozzles 50 extending around the inner perimeter of the washing assembly 40 at the sloped nozzle bore surface 64. This configuration of nozzle bores 54 and nozzles 50 allows for complete three hundred sixty degree coverage of a subject tubular 90; though other configurations of nozzle bores 54 may also produce three hundred sixty degree coverage of fluid expulsion.

Alternatively, one or more washing assemblies 40, as described herein or otherwise, may be positioned along the length of the wellbore as needed to effect satisfactory washing of the tubular 90. The washing assemblies 40 may be in series with a desired amount of space separating the assemblies 40.

In operation, the upper 41 and lower 42 members of the washing assembly 40, or other apparatus where applicable, are operationally coupled in a coupling step. Alternatively, the washing assembly 40 may be formed in a single piece. Alternatively, the washing assembly 40 may be formed in more than two pieces wherein the coupling step will encompass functionally coupling the respective pieces to form the operation washing assembly 40. Further, the pieces of the washing assembly 40 may not require physical connection in order to perform the desired function, in this situation the pieces of the washing assembly 40 shall be functionally coupled as designed to effect the stated purpose.

The coupling step may further include a groove 104, 106 aligning step allowing for the grooves 104, 106 of the lower 42 and upper 41 members to be aligned such that at least one channel 156 is formed thereby. Wherein the channel 156 is defined by the corresponding grooves 104 and 106. Alternatively, if the washing assembly 40 contains additional grooves and/or discontinuous grooves, then one or more sets of the grooves 104, 106 may be designed to align thereby forming more than one channel 156.

The coupling step may further include a channel aligning step wherein at least one upper member 41 fluid channel 94 and at least one lower member 42 fluid channel 52 may align when the members 41 and 42 are combined (two sets of channels are depicted as aligned in FIG. 7). However, the channel aligning step may not be necessary as the fluid will flow through at least one upper member 41 fluid channel 94 and through the combined channel 156 thereby dispersing the fluid to the various ports 47 of the lower member 42 contained along the groove 104. The fluid will then flow through the respective ports 47 into the corresponding fluid channels 52. The fluid will continue to flow through the individual fluid channels 52 and through the corresponding nozzles 50 and/or nozzle bores 54. The fluid will ultimately be expelled through the nozzle bores 54 into at least a portion of the internal bore 58 of the washing assembly 40.

Through the function of the channel 156, it is not necessary that each nozzle 50/nozzle bore 54 and corresponding fluid channel 52 contain direct access to a fluid fitting 20. Further, even when the fluid channels 94, 52 are aligned, additional fluid may traverse the channel 156 formed by the grooves 104, 106 thereby entering additional ports 47 within the lower member 42 further dispersing the fluid through the nozzle bores 54. Additionally, it is possible that the washing assembly 40 contain several fluid fittings 20 operationally coupled to various fluid channels 94.

A placing step comprises placing a washing apparatus capable of providing pressurized fluid in operational placement to wellbore. The placing step may provide that the washer assembly 40 be inserted or placed into the spool 32. The insertion may allow for the washing assembly 40 to rest upon the seat 36, or may be augmented by additional coupling procedures coupling the washing assembly 40 to the spool 32 or otherwise along the interior of the wellbore, or adjacent to the opening of a wellbore, wherein the tubular 90 may be passed therethrough or therealong for cleaning.

In embodiments wherein the spool 32 is not utilized, the placing step will provide for the placement of the washing assembly 40 within or functionally coupled to a wellbore or component for use with the wellbore wherein the washing assembly 40 is to be operated. The placing step may be coupled to a retaining step wherein the washing assembly 40 is retained within the spool 32, wellbore, or other component in an operating position.

A retaining step provides for the retainment of the washing assembly 40 or apparatus to prevent undesired axial movement along the spool, wellbore/borehole, or other component utilized with the washing assembly 10, and/or in relation to the tubular 90. The retaining step may be achieved through the use of the retainer 30 wherein the retainer 30 is inserted into the spool 32, or other component, and set to rest upon, or act upon, the washing assembly 40 or apparatus. The retainer 30 may be attached, either removably or fixedly or integrally, to the washing assembly 40 or apparatus. Further, the sleeve 12 is removably or fixedly attached to the spool 32 and/or the retainer 30 to further retain the washing assembly 40 or apparatus in place. The sleeve 12 prevents dislodgement of the retainer 30 allowing for the retainment of the washing assembly 40 or apparatus thereby.

The washing apparatus will be secured along the wellbore to prevent axial movement in relation to the tubular 90 so that the washing assembly 40 or apparatus can affect the desired portion of the tubular 90 or other downhole component. In other words, if the washing assembly 40 or apparatus moved with the tubular 90 so that only a part of the tubular 90 received the pressurized fluid then that would not allow for the washing of the length of the tubular 90.

Alternatively, the sleeve 12 may not have a retaining member 12 that functions to retain the retainer 30 against the washing assembly 40, see FIGS. 9 and 10. In that case, the retaining step comprises retaining the washing assembly 40 within the spool by abutment of the upper end 144 of the spool 32 and/or the upper end 150 of the sleeve 12 and/or the upper surface 72 of the washing assembly 40 against the gooseneck or other apparatus that is connected thereto.

A docking formation step may include forming the installation slot 124 within the wall of the spool 32 and the wall 132 of the upper member 41 and/or lower member 42. The slots 124 may be formed while the spool 32 and upper member 41 are coupled or may be formed independently on each individual piece. If formed separately, the slot 124 will be designed such that the fluid fitting dock 114 of the upper member 41 and the cavity 122 of the spool 32 will functionally align when they are in use. In embodiments wherein the nozzle bores 54 are located on both the upper 41 and lower 42 members, the dock forming step may be repeated for each member 41, 42. In embodiments wherein more than one installation slot 124 is desired, the docking formation step may be repeated as needed.

The number of installation slots 124 produced will depending on the number of fluid fittings 20 to be utilized with the washing assembly 10 at any given time. Additional installation slots 124 may be formed as needed. Alternatively, additional installation slots 124 may be formed and reversibly plugged such that they can be quickly employed during cleaning operations as needed.

A correcting step may be necessary to correct a malfunction in the washing assembly 40 or apparatus, fluid channel 94, fluid fitting 20, dock 114, or some other item or combination of items. A malfunction may occur if one of the aforementioned, or another passageway of the washing assembly 40 becomes clogged or otherwise deteriorates such that the fluid flow therethrough is no longer efficient; this is not the only instance of malfunction. The correcting step may include forming a new dock 114 proximate an additional fluid channel 94. This step may include repositioning the washing assembly 40 such that the existing cavity 122 of the spool 23 may be utilized to form an operable installation slot 124 with the newly formed dock 114. The forming of an additional cavity 122 may be required. The correcting step may include forming a new cavity 122 in a separate location along the spool 32 that corresponds to a newly formed dock 114. Alternatively, additional docks 114 and/or cavity 122 may have been formed prior to the replacing step and/or use of the washing assembly 40 and reversibly sealed, the seal may be removed and the dock 114 and/or cavity 122 may be positioned for coupling with the fluid source. Alternatively, the existing cavity 122 and/or dock 114 may be plugged.

The connecting step comprises connecting the washing apparatus to a fluid source. As with any of the embodiments contained herein, the fluid may be water alone or may be water or other fluids in combination. The combinations may include the use of cleaning preparations and/or radioactive neutralizers if desired. The connecting step allows a fluid source to be operationally connected to the washing assembly 40 or apparatus such that fluid may be transferred from the fluid source to the washing assembly 40 or apparatus for use with a tubular 90 or the like. The connecting step may include inserting a fluid fitting 20 into an installation slot 124. The fluid fitting 20 may be previously coupled to a fluid source or the coupling to the fluid source may occur after the fluid fitting 20 is connected at the installation slot 124. The fluid source may be coupled to the washing assembly 40 in any known or later discovered manner as needed. Once the fluid fitting 20 is connected to the washing assembly 40, at least a portion of the fluid fitting 20 will be positioned within at least a portion of the washing assembly 40 to allow the pressurized fluid to flow through at least one channel member 94.

Once the washing assembly 10 is functionally coupled to the wellbore, and functionally coupled to a fluid source, the fluid is injected into the washing assembly 40 from the external source (not shown). An expelling step provides for the forceful expulsion of the fluid through the washing assembly 40 or apparatus and onto the tubular 90 or like member providing for the desired level of cleansing of the tubular 90 or the like. The fluid proceeds through the washing assembly 40 and is expelled through the nozzles 50 and/or nozzle bores 54. In an exemplary embodiment, the fluid is pressurized at or about 23,000 psi.

The expelling step removes at least some of the naturally occurring radioactive materials and/or other radioactive materials, and/or other hazardous and nonhazardous materials from the tubular 90 or other downhole component and washes the material down into the wellbore.

A tubular removing step allows for the removal of the tubular 90 or like member from the wellbore wherein at least a portion of the tubular 90 is passed through the fluid that is being expelled from the washing assembly 40. As the downhole tubular 90 is pulled through the washer assembly 40 or apparatus, the pressurized fluid washes over surface of the tubular 90 and washes away naturally occurring radioactive materials and/or other radioactive materials, and/or other hazardous and nonhazardous materials. These materials are washed down into the wellbore as the tubular 90 is removed from the wellbore.

A fluid ceasing step allows for the cessation of the fluid flow through the washing assembly 40. This step may be accompanied by a fitting removal step wherein the fluid fitting(s) 20 from the washing assembly 40 and/or spool 32 are removed. The fitting removal step may not occur until after the washing assembly removal step or at some other appropriate time.

A washer removing step includes removing the washing assembly 40 or apparatus from operational connection with the wellbore. This step may include removal of the unit 10 as a whole, i.e., the spool 32, sleeve 12, retainer 30, and washing assembly 40. The step may alternatively include removal of the constituent parts of the whole as desired in order to remove all or a part of the downhole tubular washer 10. When a spool 32 or other components disclosed herein are not utilized with a washing assembly 40, or other washing apparatus used under the disclosure herein, the washer removing step comprises removal of the washing assembly 40 or apparatus from operational connection with the borehole.

Further, the washer removing step may encompass a washing assembly 40 removing step wherein the washing assembly 40 and/or apparatus is removed from the unit 10. The washing assembly 40 and/or apparatus may be removed for repair or replacement as needed. The removal may include removal of the sleeve 12 and/or the retainer 30 in order to have access to the washing assembly 40, when needed.

The washer removing step entails removing the washing apparatus from the wellbore whether for repair, replacement, or because its services are no longer required. The coupling for the fluid may be removed from the washing assembly either before or after the washing assembly is removed form the wellbore.

The washing of the tubulars, or other downhole components, wherein the naturally occurring radioactive materials and/or other radioactive materials, and/or other hazardous and nonhazardous materials are washed downhole may be accomplished without the use of the specified apparatus disclosed herein but with any apparatus capable of performing the same function. The method may comprise the aforementioned steps as applicable wherein the washing apparatus is used rather than the washing assembly 40.

The depicted exemplary embodiments may be altered in a number of ways while retaining the inventive aspect, including ways not specifically disclosed herein.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features and characteristics described in conjunction with a particular aspect, embodiment or example of the invention are to be understood to be applicable to any other aspect, embodiment or example described herein unless incompatible therewith.

All of the features disclosed in this specification (including any accompanying claims, abstract and drawings), and/or all of the steps of any method or process so disclosed, may be combined in any combination, except combinations where at least some of such features and/or steps are mutually exclusive. In other words, the method steps have not been provided for in any particular sequential order and may be rearranged as needed or desired, with some steps repeated sequentially or at other times, during use.

Each feature disclosed in this specification (including any accompanying claims, abstract and drawings), may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

I claim:

1. An apparatus for cleaning downhole tubulars and the like comprising:
a washing assembly;
said washing assembly having at least one nozzle bore capable of functional coupling to at least one fluid source; and
wherein said washing assembly is capable of functional coupling to the interior of a borehole.

2. The apparatus of claim 1, further comprising a retainer, wherein said retainer is positioned proximate said washing assembly to prevent movement of said washing assembly along the length of said borehole.

3. The apparatus of claim 1, further comprising:
at least one nozzle functionally coupled to said at least one nozzle bore and said at least one fluid source;
said washing assembly having an internal bore extending axially therethrough; and
wherein said at least one nozzle is at least partially angled towards said internal bore of said washing assembly.

4. The apparatus of claim 1, further comprising:
at least one fluid channel extends within said washing assembly, wherein said at least one fluid channel is capable of functional connection with said fluid source and said at least one nozzle bore;
at least one port channel extending laterally within said washing assembly; and
said at least one port channel being functionally coupled to at least a portion of said at least one fluid channel.

5. The apparatus of claim 4, further comprising:
said washing assembly having a lower member and an upper member; and
said upper member having at least one nozzle bore functionally coupled to said fluid source, and said lower member having at least one nozzle bore functionally coupled to said fluid source or a different fluid source.

6. The apparatus of claim 4, further comprising:
said washing assembly having a lower member and an upper member;
said lower member having a lower member mating surface wherein at least one groove extends along at least a portion of said lower member mating surface;
said upper member having an upper member mating surface wherein at least one groove extends along at least a portion of said upper member mating surface; and
wherein said at least one port channel is formed through the alignment of said corresponding grooves.

7. The apparatus of claim 6, further comprising:
said at least one groove on said upper member having at least one port thereon, wherein said upper member port is in fluid communication with said fluid source; and
said at least one groove on said lower member having at least one port thereon, wherein said lower member port is in fluid communication with said at least one nozzle bore.

8. The apparatus of claim 7, further comprising:
wherein said washing assembly is formed from more than one member; and
wherein at least one of said grooves is discontinuous.

9. The apparatus of claim 7, wherein at least one of said upper member ports and one of said lower member ports align when said upper member and said lower member are functionally coupled.

10. The apparatus of claim 7, further comprising:
at least one dock formed in a wall of said washing assembly, wherein said at least one dock intersects at least a portion of said fluid channel;
wherein said at least one dock is sized to accept at least a portion of a fluid fitting therein; and
wherein said fluid fitting is capable of functional coupling to said fluid source.

11. The apparatus of claim 10, further comprising:
a spool having a longitudinal bore extending therethrough;
said longitudinally extending bore sized to accept at least a portion of a tubular therein; and
wherein at least one washing assembly is disposed along the interior of said spool.

12. The apparatus of claim 11, further comprising:
said spool having an inner diameter, wherein at least a portion of said inner diameter, proximate said spool's upper opening, is smaller than at least a portion of the remaining inner diameter;
wherein the junction where said inner diameter changes from larger to smaller defines a seat for placement of said washing assembly thereon; and
at least one cavity formed in a wall of said spool, wherein said cavity is capable of functional alignment with at least one dock.

13. The apparatus of claim 11, further comprising:
a retainer, wherein said retainer is positioned proximate said washing assembly to prevent movement of said washing assembly along the length of said borehole;
said retainer sized to be received within said spool intermediate said seat and said upper opening of said spool, and to allow a tubular to move therethrough;
a sleeve; and
said sleeve attached to said spool proximate said upper opening of said spool.

14. An apparatus for cleaning downhole tubulars and the like comprising:
a washing assembly, wherein said washing assembly is annular;
said washing assembly having an internal bore extending axially therethrough;
said washing assembly having at least one nozzle bore capable of functional coupling to at least one fluid source thereby allowing fluid communication from said fluid source to at least a portion of the internal washing assembly bore;
said washing assembly having at least one fluid channel extending at least partially within said washing assembly that is functionally coupled to said nozzle bore; and
wherein said washing assembly is capable of functional coupling to the interior of a borehole.

15. The apparatus of claim 14, further comprising:
wherein said washing assembly is formed from more than one member;
at least one nozzle functionally coupled to said at least one nozzle bore and said at least one fluid source;
wherein said at least one nozzle is at least partially angled towards said internal bore of said washing assembly;
wherein said at least one fluid channel is capable of functional connection with said fluid source and said at least one nozzle bore;
at least one port channel extending laterally within said washing assembly; and
said at least one port channel being functionally coupled to at least a portion of said at least one fluid channel.

16. The apparatus of claim 15, further comprising:
said washing assembly having a lower member and an upper member;
said lower member having a lower member mating surface wherein at least one groove extends along at least a portion of said lower member mating surface;
said upper member having an upper member mating surface wherein at least one groove extends along at least a portion of said upper member mating surface;
said at least one groove on said upper member having at least one port thereon, wherein said upper member port is in fluid communication with said fluid source;
said at least one groove on said lower member having at least one port thereon, wherein said lower member port is in fluid communication with said at least one nozzle bore; and
wherein said at least one port channel is formed through the alignment of said corresponding grooves.

17. The apparatus of claim 16, further comprising:
a retainer, wherein said retainer is positioned proximate said washing assembly to prevent movement of said washing assembly along the length of said borehole;
at least one dock formed in a wall of said washing assembly, wherein said at least one dock intersects at least a portion of said fluid channel;
wherein said at least one dock is sized to accept at least a portion of a fluid fitting therein; and
wherein said fluid fitting is capable of functional coupling to said fluid source.

18. The apparatus of claim 17, further comprising:
a spool having a longitudinal bore extending therethrough and an inner diameter;
said longitudinally extending bore sized to accept at least a portion of a tubular therein;
at least one cavity formed in a wall of said spool, wherein said cavity is capable of functional alignment with at least one dock;
wherein at least a portion of said inner diameter, proximate said spool's upper opening, is smaller than at least a portion of the remaining inner diameter;
wherein the junction where said inner diameter changes from larger to smaller defines a seat for placement of said washing assembly thereon;
wherein at least one washing assembly is disposed along said interior of said spool;
wherein said retainer is positioned proximate said washing assembly to prevent movement of said washing assembly along the length of said borehole;
said retainer sized to be received within said spool intermediate said seat and said upper opening of said spool, and to allow a tubular to move therethrough;
a sleeve; and
said sleeve attached to said spool proximate said upper opening of said spool.

19. A method of cleaning downhole tubulars, comprising:
a placing step comprising placing a washing apparatus, capable of functional coupling with a fluid source and expelling a fluid therefrom, in a functional relation with the interior of a borehole;
a connecting step comprising functionally connecting said fluid source to said washing apparatus; and
an expelling step comprising expelling said fluid from said washing apparatus onto at least a portion of a tubular wherein material is removed from said tubular and washed down into said borehole.

20. The method of claim 19, further comprising a correcting step comprising correcting a malfunction in the washing apparatus.

21. The method of claim 19, further comprising:
a tubular removing step comprising removing said tubular from said borehole through at least a portion of said expelled fluid; and
a fluid ceasing step comprising ceasing the flow of said fluid through said washing apparatus.

22. The method of claim 19, further comprising:
a coupling step, wherein said washing apparatus is comprised of more than one member, comprising functionally coupling the components of said washing apparatus together; and
a retaining step comprising retaining said washing apparatus in functional relation to said borehole.

23. The method of claim 22, further comprising:
a docking formation step comprising forming a dock to house at least a portion of a fluid fitting, wherein said fluid fitting provides fluid communication from said fluid source to said washing apparatus; and
wherein said coupling step further comprises a groove aligning step comprising aligning at least one groove on one member of said washing assembly and at least one groove on a second member of said washing assembly.

24. The method of claim 23, wherein said docking formation step further comprises forming a cavity within a wall of a spool, wherein said cavity is functionally alignable with at least one dock in said washing apparatus.

25. The method of claim 19, further comprising:
a washing apparatus removing step comprising removing said washing apparatus from its operational coupling to said borehole; and
where said placing step further comprises placing said washing apparatus into a spool;
